(19) United States
(12) Patent Application Publication
(10) Pub. No.: US 2016/0342949 A1
(43) Pub. Date: Nov. 24, 2016

(54) INFORMATION SHARING SYSTEM, INFORMATION SHARING METHOD, AND INFORMATION SHARING PROGRAM

(71) Applicant: SEVENDAYS, INC., Tokyo (JP)

(72) Inventors: Toru TAKASUKA, Tokyo (JP); Hideshi HAMAGUCHI, Tokyo (JP); Shinichi HOSOKAWA, Tokyo (JP)

(73) Assignee: SEVENDAYS, INC., Tokyo (JP)

(21) Appl. No.: 15/111,616

(22) PCT Filed: Jan. 17, 2014
(86) PCT No.: PCT/JP2014/050749

§ 371 Date: Jul. 14, 2016

(51) Int. Cl. G06Q 10/10; G06F 3/0485

(52) U.S. Cl. CPC G06Q 10/1093; G06F 3/0485; G06Q 50/01

(57) ABSTRACT

To share short-term future schedules of the user and others used in mobile terminal devices by using social networking services. The information sharing system includes an information sharing server, an information sharing server database connected to the information sharing server and saves schedule data, and a mobile terminal device including a control unit, a display device, an input device, a storage device, and a communication device, wherein: the control unit acquires into the storage device the schedule data for a plurality of days and people from the information sharing server database connected to the information sharing server via the communication device and the communication network, and displays the acquired schedule data on a display screen of the display device with a tile screen; and the tile screen displayed on the display screen is scrolled in lateral and vertical directions by operating the input device for display.

### CROSS-REFERENCE TO RELATED APPLICATION

This application is a U.S. National Phase Application of International Application No. PCT/JP2014/050749, filed on Jan. 17, 2014 and published in Japanese as WO 2015/107668 on Jul. 23, 2015. The entire disclosure of the above application is incorporated herein by reference.

### TECHNICAL FIELD

The present invention relates to an information sharing system, an information sharing method, and an information sharing program, which are used in mobile terminals for sharing near-future schedules of the user oneself and others by using Social Networking Service (referred to as SNS hereinafter) systems.

### BACKGROUND ART

For managing schedules, recently used are systems which share and manage schedules among a plurality of people by utilizing communication networks of computer systems.

JP-A No. 2002-41733 discloses a schedule management system and a mobile phone, with which: a plurality of schedule bulletin boards are provided on the Internet by individually corresponding to a plurality of schedules such as schedules for workplace, circle of friends, and family members by using the mobile phones; and the respective members register and manage the schedules of the workplace, the circle, and the family members on the schedule bulletin boards for making it easy to control and manage the plurality of schedules.

JP-A No. 2005-84761 discloses an invention for improving the convenience of the users, which executes preferable information display with which display lines of higher preferential orders are displayed in order from higher ranks in a case where information related to schedules is displayed by using a plurality of display lines in a schedule setting period displayed on groupware.

### SUMMARY OF INVENTION

### Technical Problem

JP-A No. 2002-41733 discloses the invention with which the person in charge of each group writes common schedules and only the members of that group can check the schedules. JP-A No. 2005-84761 describes that the person who writes a schedule selects the members regarding that schedule at the time of entry and registers that schedule.

Determined plans for the time, places, and the like for the schedule are registered, and used as the information to be informed to the members registered to the group. As a method for other users to make a comment on that schedule, it is required to use a means for communication such as an e-mail or a note. Further, there is an inconvenience that a limit is set in viewing the schedule for those other than the registered members.

Further, as shown in FIG. 2 of JP-A No. 2002-41733 and FIG. 5 of JP-A No. 2005-84761, it is necessary to input and save the data of the time (period), places, comments and the like of those schedules at the time of entry. Input styles for the conventional schedules used as memorandums are determined as described above, so that the use thereof is suited for inputting the settled plans such as past information and current information. However, the use thereof is not suited for plans such as those with a part being unsettled or those with uncertain future information. Further, in a case where the members use different languages, contradictions may occur in understanding the content.

It is therefore an object of the present invention to provide an information sharing system, an information sharing method, and an information sharing program for providing schedules using SNS, with which information is shared through creating individual schedules easily by using stickers configured with illustrations and disclosing the near-future schedules to a specified number of people that are permitted to make an access so that the schedules can be changed and settled flexibly according to the reactions from the specified number of people made on the schedules.

### Solution to Problem

The information sharing system according to the present invention includes at least an information sharing server, an information sharing server database that is connected to the information sharing server and saves schedule data, and a mobile terminal device which includes a control unit, a display device, an input device, a storage device, and a communication device, characterized in that: the control unit acquires into the storage device the schedule data for a plurality of days and a plurality of people from the information sharing server database connected to the information sharing server via the communication device and the communication network, and displays the acquired schedule data on a display screen of the display device with a tile screen; and the tile screen displayed on the display screen is scrolled in lateral directions and vertical directions by operating the input device for display.

The information sharing system according to the present invention is characterized in that the tile screen displays the schedule data of one person for one day on an entire region of the display screen.

The information sharing system according to the present invention is characterized in that: the schedule data contains a single or a plurality of individual schedule data that can be displayed on a single tile screen; and the individual schedule data is configured with a single sticker or a plurality of stickers.

The information sharing system according to the present invention is characterized in that the plurality of stickers are stored by being classified according to each purpose.

The information sharing system according to the present invention is characterized in that a first viewing mode for displaying the tile screen on the display screen of the display device and a second viewing mode for displaying a plurality of brick screens can be switched mutually.

The information sharing system according to the present invention is characterized in that scrolling of the tile screen displayed on the display screen stops and displays each of the tile screens.

The information sharing system according to the present invention is characterized in that the schedule data for the plurality of days acquired from the information sharing server database are the schedule data for seven days.

The information sharing system according to the present invention is characterized to include a display measure which indicates that a comment to be inputted to the schedule data is already being inputted to the individual schedule data of another user on the brick screen.

An information sharing method according to the present invention is used with an information sharing system which comprises at least an information sharing server, an information sharing server database that is connected to the information sharing server and saves schedule data, and a mobile terminal device which includes a control unit, a display device, an input device, a storage device, and a communication device, characterized in that: the control unit acquires into the storage device the schedule data for a plurality of days and a plurality of people from the information sharing server database connected to the information sharing server via the communication device and the communication network, and displays the acquired schedule data on a display screen of the display device with a tile screen; and the tile screen displayed on the display screen is scrolled in lateral directions and vertical directions by operating the input device for display.

An information sharing program according to the present information is used with an information sharing system which includes at least an information sharing server, an information sharing server database that is connected to the information sharing server and saves schedule data, and a mobile terminal device which includes a control unit, a display device, an input device, a storage device, and a communication device, characterized in that: the control unit acquires into the storage device the schedule data for a plurality of days and a plurality of people from the information sharing server database connected to the information sharing server via the communication device and the communication network, and displays the acquired schedule data on a display screen of the display device with a tile screen; and the tile screen displayed on the display screen is scrolled in lateral directions and vertical directions by operating the input device for display.

### Advantageous Effects of Invention

According to the present invention, the user can make a schedule easily by selecting a single sticker or a plurality of stickers. There are a plurality of stickers in groups for each purpose, so that the user may simply select the sticker that fits the own purpose.

Further, the individual schedules are created by using the stickers, so that it is possible to create the schedules not relying on character information. Furthermore, since the content can be easily comprehended by the illustrations of the stickers, it is possible to mutually communicate with the others (friends) who view the schedule regardless of the languages.

According to the present invention, it is possible to create and disclose the schedule of one-screen size for only the seven days of near future from the data of the use. Thus, the plans for the near future can be easily arranged, and input can be done without hesitation since the input is for a short period of time.

Further, unsettled imprecise near-future plans can be registered to the schedule by using the stickers. Through disclosing the schedule to a specified number of people who are allowed to make an access, comments for that schedule can be acquired from other users (friends). Also, the schedule can be changed and settled easily based on the acquired comments.

Further, since the schedule for one day is displayed on a screen, the schedule can be easily grasped at a glance. Also, the stickers can be arranged at arbitrary positions within one screen.

Further, when the screen is scrolled in the lateral direction while the schedule screen of the user for one screen is being displayed, the schedule screen of the user of another date is displayed. Meanwhile, when the screen is scrolled in the vertical direction, the schedules of other users (friends) of that date are displayed. Therefore, the schedules of other users (friends) can be viewed easily.

Further, scrolling in both the lateral and vertical directions automatically stops in the center of the next schedule screen. Therefore, the screen never stops in the middle of the schedule screen and the next schedule screen during the scroll, so that the user does not feel a sense of stress while scrolling the screen.

Further, since the initial setting of the information sharing server is done by referring to the information of other SNS, introduction thereof can be done easily.

### BRIEF DESCRIPTION OF THE DRAWINGS

FIG. 1 is a chart of a system configuration according to the present invention;

FIG. 2 is a block diagram according to the present invention;

FIG. 3 is a conceptual diagram showing a screen configuration;

FIG. 4A is an illustration of a home screen (first viewing mode) according to the present invention showing the schedule for the day, FIG. 4B is an illustration showing a case where there is no schedule on that day, FIG. 4C is an illustration of a home screen showing a schedule of a day after, and FIG. 4D is an illustration of a home screen showing the schedule of a friend (F1) for the day;

FIG. 5 shows illustrations of screens when inputting stickers, in which FIG. 5A is an illustration showing an input screen of “What” stickers, FIG. 5B is an illustration showing an input screen of “When” stickers, FIG. 5C is an illustration showing an input screen of “Who” stickers, and FIG. 5D is an illustration showing an input screen of “How” stickers;

FIG. 6 shows illustrations for describing sticker pasting actions;

FIG. 7 is an illustration showing a brick screen (second viewing mode) according to the present invention;

FIG. 8 shows illustrations of comment input screens at the time of pressing down a comment button according to the present invention, in which FIG. 8A is an illustration showing a comment input screen of the first viewing mode and FIG. 8B is an illustration showing a comment input screen of the second viewing mode;

FIG. 9 shows illustrations of screens when processing a main menu, in which FIG. 9A is an illustration showing a calendar screen, FIGS. 9B and 9C are illustrations showing activity screens, and FIG. 9D is an illustration showing a follow screen;

FIG. 10 shows illustrations of an input selection menu, in which FIG. 10A is an illustration showing a text screen and FIG. 10B is an illustration showing a wallpaper input screen;

FIG. 11 is a processing flowchart according to the present invention;

FIG. 12 is a sequence chart according to the present invention; and

FIG. 13 is an illustration showing a profile screen according to the present invention.

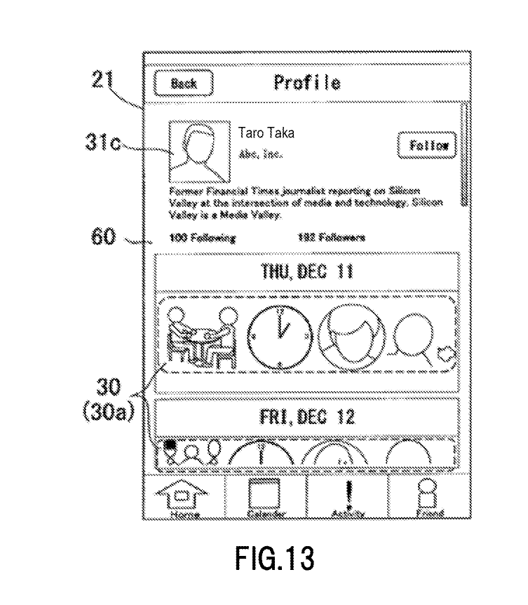

### DESCRIPTION OF EMBODIMENTS

### First Embodiment

Hereinafter, embodiments of the present invention will be described in details by referring to accompanying drawings.

### System Configuration

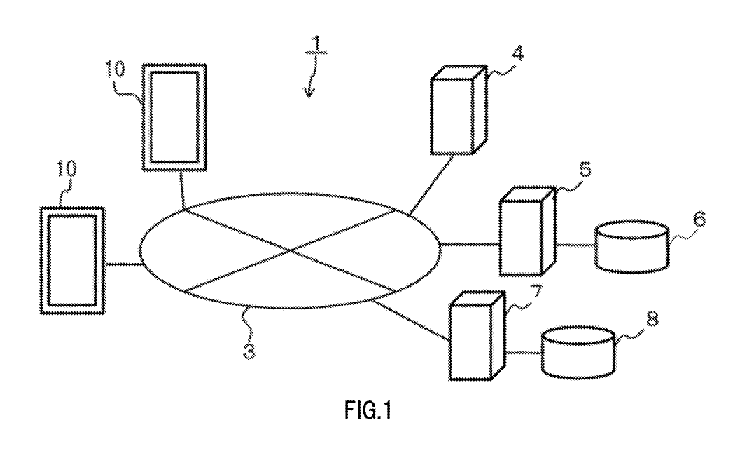

As shown in FIG. 1, with an information sharing system 1 according to the present invention, each user makes an access to an information sharing server 7 connected to a communication network 3 by using a mobile terminal device 10 that is provided with a telephone function and an internet function and downloads and operates the information of each user saved in an information sharing server database 8. Thereby, another user (referred to as “friend” hereinafter) who is permitted to view the schedule data of the user can view the information regarding the schedule, leave a comment, and so on.

Further, at the time of the initial setting, application software 9 (referred to as “app 9” hereinafter) according to the present invention is downloaded from an application software download server 4 and installed. Furthermore, necessary information is acquired from an SNS server database 6 by making an access to an SNS (social networking service) server 5, and the information is registered to the information sharing server database 8.

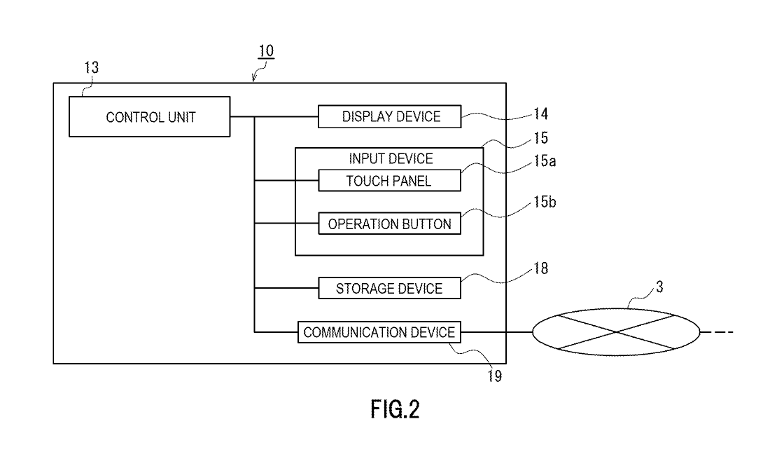

As shown in FIG. 2, the mobile terminal device 10 includes a control unit 13, a display device 14, an input device 15, a storage device 18, and a communication device 19. The mobile terminal device 10 may be any devices such as a tablet terminal device, a notebook personal computer, a desktop personal computer, a mobile phone, a smartphone, a PDA (Personal Digital Assistant) and the like as long as the app 9 can work thereon. Further, the OS (Operation System) may be any types such as iOS (registered trademark) for mobile terminals, Android (registered trademark), and OS for personal computers and the like such as Mac OS (registered trademark), MS-Windows (registered trademark), and the like. Furthermore, input devices may be any types such as a mouse, a tablet, a touch panel, and the like, which can be operated by users for inputting to the terminal device. The embodiment will be described by referring to a case of the mobile terminal device with a small portable touch-panel input form.

The control unit 13 is configured with a CPU and the like, which executes a function of receiving/transmitting signals with various kinds of devices such as the storage device 18 and the like and of controlling the actions of the mobile terminal device 10. Specifically, the control unit 13 executes processing of the app 9, communication processing, and the like.

The display device 14 is configured with a liquid crystal display and the like, and it is a device for displaying the operation state of the mobile terminal device 10 and the app 9. A touch panel 15a of the input device 15 is placed on the surface thereof on the user side.

The input device 15 includes the touch panel 15a and an operation button 15b.

The touch panel 15a is placed on the surface of the display device 14. The user executes operations of icons and the buttons of the apps displayed on the display of the display device 14 and input operations of characters and the like by touching the screen with a finger directly or by a stylus pen. The use of the touch panel makes it possible to execute intuitive and quick operations. There are mainly the electrostatic type and the resistance film type as the touch panels, and both of those types can be used with the present invention.

The operation button 15b exhibits a function of switching to another app and another menu screen by being pressed down during execution of the app 9. Further, the operation button 15b may also have other functions.

The storage device 18 includes a volatile memory (Random Access Memory: RAM), a nonvolatile memory, a hard disk, and the like. The RAM is used for temporary saving while the mobile terminal device 10 is in operation, and the data that is not to be erased, e.g., the initial setting and the like of the mobile terminal device 10, is saved in the hard disk or the nonvolatile memory. Further, the app 9 is installed and saved in the nonvolatile memory or the hard disk, and expanded in the RAM when executing a program. The control unit 13 executes the app 9.

The communication device 19 is a device which enables the mobile terminal device 10 to perform communication by connecting to the communication network 3. As the communication modes between the mobile terminal device 10 and the communication network 3, any connection modes such as types using W-CDMA, CDMA 2000, and the like as the data communication of mobile phones, types using Bluetooth (registered trademark), Wi-Fi (wireless fidelity: registered trademark), IrDA (Infrared Data Association), and the like as wireless modes, types using a coaxial, optical cable, and the like such as Ethernet (registered trademark) as a cable mode may be employed. Any configurations may be employed as long as data can be transmitted and received mutually between the communication network 3 and the mobile terminal device 10.

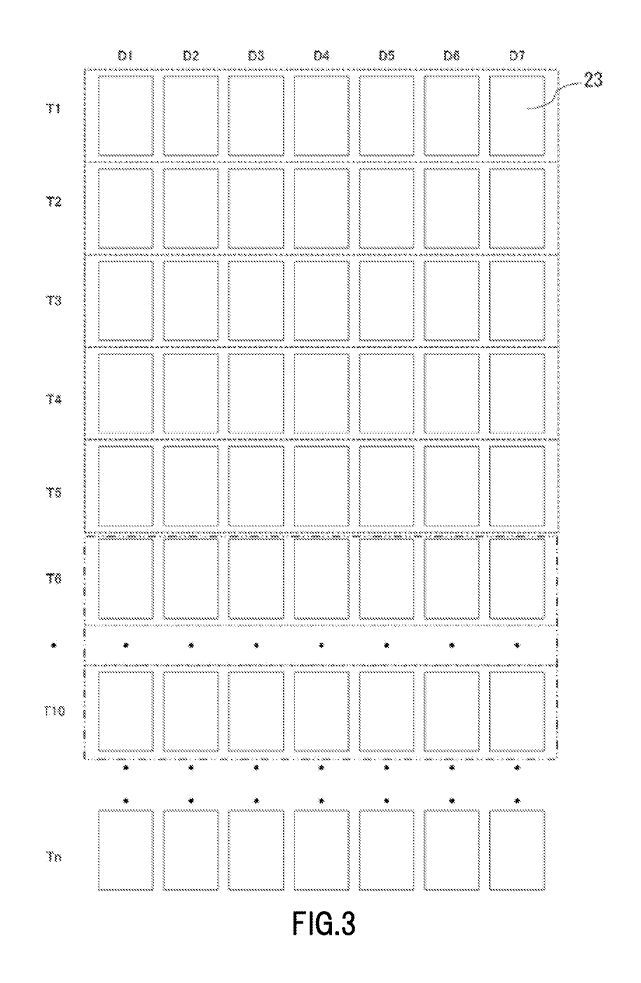

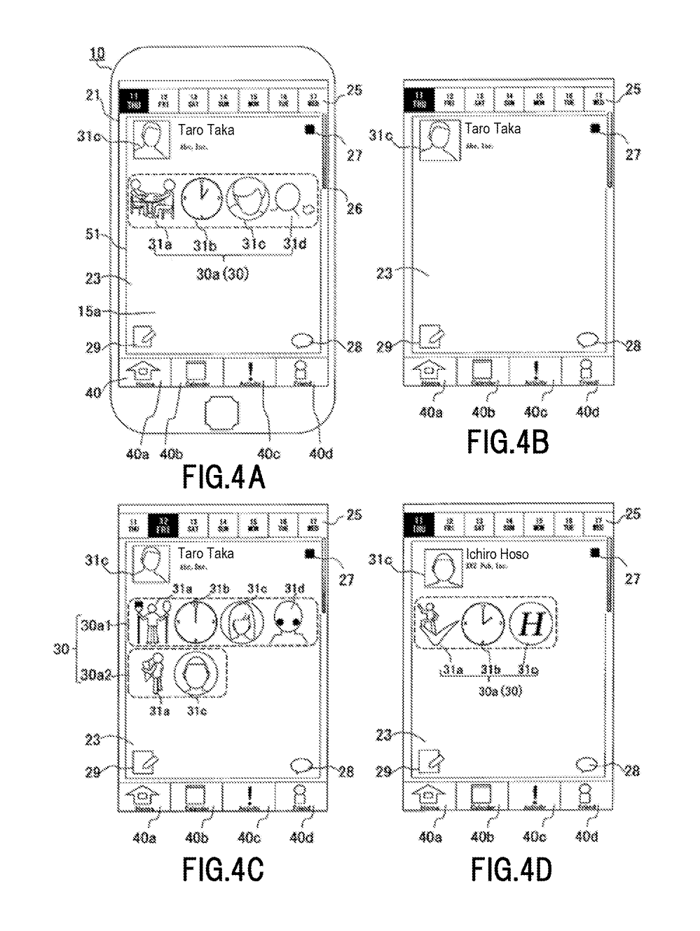

Next, described by referring to FIG. 3 and FIG. 4 are the screens displayed on the display device 14 when the app 9 is executed on the mobile terminal device 10 under a state where download of the app 9 is completed with the above-described initial setting.

### First Viewing Mode

When the app 9 is started up by the user, an operation screen of the app 9 being executed is displayed on a display screen 21 that is the display device 14 as shown in FIG. 4. FIG. 4A shows a first viewing mode 51 (basic screen) of the app 9, which includes a tile screen 23, a date display section 25, a scroll bar 26, an input button 29, a comment button 28, a viewing mode switching button 27, a main menu 40, and the like.

The tile screen 23 forms a single tile-like screen, which displays schedule data 30 configured with a single or a plurality of individual schedule data 30a. As shown in FIG. 3, the sizes of the tile screen 23 both in the vertical direction and the lateral direction are fixed and cannot be changed. Thus, the individual schedule data 30a the user can write on the tile screen 23 for one day is limited to be within a range of the tile screen, which is about four to five items.

The date display section 25 is located at the upper end of the display screen, on which the dates (D1 to D7) that are seven days from the date of the use of the embodiment and the days of the week are displayed in a tag format. Thus, the data out of that period, i.e., the days before the date of the use and the days after the seven days, are not displayed. For example, FIG. 4A shows the tile screen of 11th, Thursday (THU), while FIG. 4C shows the tile screen of 12th, Friday (FRI). Seven-day (one-week) cycle is the period generally used for weather forecast, TV program charts, and the like, so that it is quite familiar with the users. Therefore, to employ seven-day display for the date display section 25 enables the user to grasp the schedule easily.

While the embodiment employs the period limited to seven days, the dates displayed on the date display section 25 may also be set to other period such as three days or ten days as appropriate.

### Schedule Data Scroll Method

Hereinafter, the layout of the tile screens 23 regarding the schedule data 30 and the scroll method of the screen will be described by referring to FIG. 3. FIG. 3 is a chart schematically showing the layout of the tile screens 23 which display the schedule data 30. T1 (showing the user), T2, - - - , and Tn are applied on the vertical axis for each person, and D1, D2, - - - , and D7 are applied on the lateral axis for each date for seven days. FIG. 4B shows a day having no individual schedule data 30a for one day or a screen of the first-time startup screen, for example. As shown in FIG. 4B, there is no sticker 31 displayed on the tile screen 23. Further, the schedule data 30 for one day is configured with a single or a plurality of individual schedule data 30a (see FIG. 4A and the like).

FIG. 4A shows T1D1 that is the schedule data 30 of the user, FIG. 4C shows T1D2, and FIG. 4D shows T2D1 that is the schedule data 30 of the first day of a friend on the highest rank.

First, when viewing the schedule of the next day of the user from the home screen shown in FIG. 4 (located at T1D1 shown in FIG. 3), the screen is scrolled in the left direction (swiped) by operating the touch panel 15a. The data displayed on the display screen 21 is shifted to the tile screen (T1D2) located conceptually in the upper right direction that is opposite from the swiping direction.

Further, the schedule data 30 of the out of the period other than period from the use data to the seventh day therefrom is out of the display subjects, and scroll actions are not done even when the screen is swiped in the direction before the use data and the direction after the seventh date.

When swiping the tile screen 23 by operating the touch panel 15a, the screen can be scrolled in the lateral direction and the vertical direction. However, the processing for restricting scrolling of the screen in the oblique directions is executed. For example, in T2D3 of the tile screen, scrolling to the right direction T2D4, the left direction T2D2, the upper direction T1D3, and the lower direction T3D3 is permitted. However, scrolling to T1D2, T1D4, T3D2, and T3D4 is restricted. Through restricting the scrolling in the oblique directions, the user can check the schedule data 30 of each subject person consciously at the time of executing lateral scrolling. Also, the user can check the schedule data 30 of each date consciously at the time of executing vertical scrolling.

With such scrolling in the crosswise directions, the user can more easily grasp the positional information indicating which data the user is currently viewing compared to the case of executing scrolling in the oblique directions.

When scrolling the tile screen 23, executed is the display processing with which the tile screen 23 is scrolled by a unit of one screen and the top, bottom, left, and right end sections of the scrolled tile screen 23 stop accurately on the display screen 21. That is, the scrolling of the screen never stops in the middle of the screen that is being scrolled. For example, it never happens that scrolling stops in the middle of T1D1 and T1D2 of the tile screen 23 or in the middle of T1D1 and T2D1 or stops while the border line between the both screens is being displayed on the display screen 21. Through processing the scrolling of the screen, the user can shift to the next screen by simply swiping the screen once, so that the operability can be improved. Also, it is possible to decrease the stress felt by the user when the screen that is being scrolled is displayed by being disconnected in the middle thereof.

When the date changes, the data is updated to the schedule data 30 for new seven days. D1 displayed up to that point is cancelled, and D2 is moved up to new D1. The previous data is moved up in order to be new D1 to D6. Then, the schedule data 30 of new D7 is acquired from the information sharing server 7 and stored in the storage device 18 to make new D1 to D7.

### Configuration of Individual Schedule

FIG. 4B shows a state of blank data where there is no schedule data 30 (individual schedule data 30a) inputted on the tile screen at the time of first startup after installation or in a case where a new date is set. With the embodiment, a single piece of individual schedule data 30a can be created by combining a single or a plurality of stickers 31 as shown in FIGS. 4A and 4C.

Each of What sticker 31a, When sticker 31b, Who sticker 31c, and How sticker 31d is combined in line laterally to express a piece of schedule. For example, the individual schedule data 30a shown in FIG. 4A is configured with What sticker 31a indicating “meeting”, When sticker 31b indicating “1:00”, Who sticker 31c indicating “John”, and How sticker 31d indicating “sigh”. Therefore, this schedule means that the user “Taro” has a plan to have a “meeting” with “John” at “1:00” on 11th, Thursday, but he is dispirited and feels like letting out a “sigh”. Further, the individual schedule data 30a1 shown in FIG. 4C means that the user “Taro” has a plan to have a “lunch” with “Hanako” at “12:00” on 12th, Friday, and feels “happy”. The second individual schedule data 30a2 means that the user has a plan to “read a book” with “Ichiro” on 12th, Friday. When sticker 31b is not inputted, so that the time is undecided.

As described, the individual schedule data 30a can visually and intuitively display the schedule of the user with the four stickers, i.e., “what (What sticker)”, “what time (When sticker)”, “with whom (Who sticker)”, and “how (How sticker)”. Therefore, the content of the schedule can be easily understood regardless of the use languages of the user.

### Sticker Processing

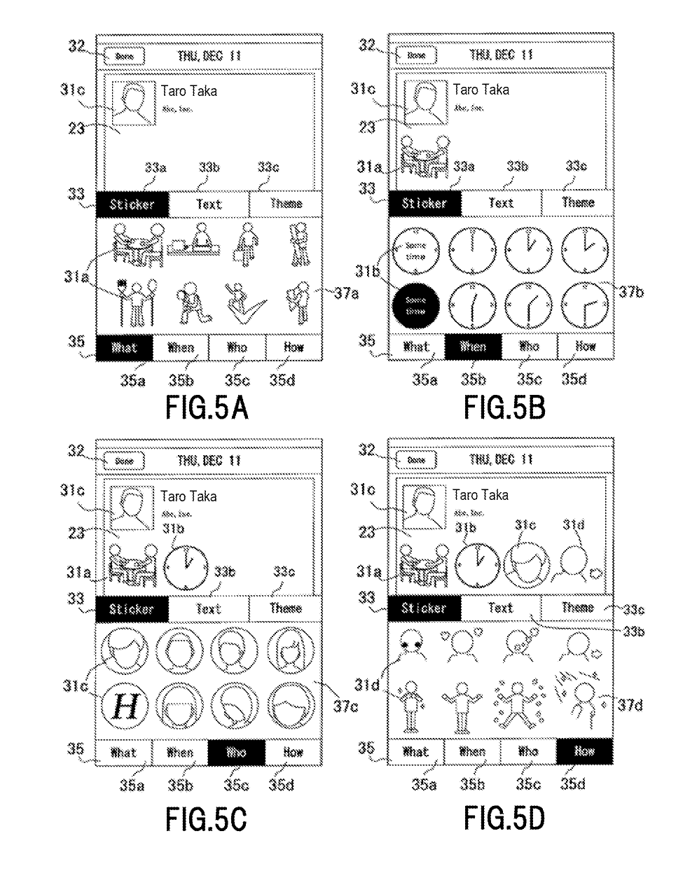

In the embodiment, four kinds of stickers that are the What sticker 31a, the When sticker 31b, the Who sticker 31c, and the How sticker 31d are prepared for each use and purpose. The stickers 31 are selections of the information required for transmitting the schedules to the third party. While the four kinds are prepared in the embodiment, the number of kinds may be increased as necessary by selecting other information required for transmitting the schedules. Further, each of the stickers 31 is classified into each sticker window 37 (see FIG. 5A and the like), and a plurality of pieces of stickers are prepared and stored so that each of those can corresponds to various kinds of use. The user can select the stickers suited for the use of oneself.

When the input button 29 shown in FIG. 4A is pressed down, the tile screen 23 being displayed is shifted to the screen for inputting and updating the information, and an input selection menu 33, a sticker menu 35, and the sticker window 37 are displayed as shown in FIGS. 5A to 5D.

As shown in FIG. 5A, the What sticker 31a is configured with illustrations of “meeting”, “going-out”, and the like. When a What sticker display button 35a is pressed down from the sticker menu 35, a What sticker window 37a is displayed, and a plurality of What stickers 31a registered to the app 9 are displayed.

As shown in FIG. 5B, the When sticker 31b is configured with illustrations of a clock. When a When sticker display button 35b is pressed down from the sticker menu 35, a When sticker window 37b is displayed, and a plurality of When stickers 31b registered to the app 9 are displayed.

The Who sticker 31c is configured with illustrations of face photos, names, and the like of the friends. When a Who sticker display button 35c is pressed down from the sticker menu 35, a Who sticker window 37c is displayed, and a plurality of Who stickers 31c that are acquired from the SNS server 5 and temporarily stored in the storage device 18 are displayed (see FIG. 5C).

The How sticker 31d is configured with illustrations expressing feelings and emotions. When a How sticker display button 35d is pressed down from the sticker menu 35, a How sticker window 37d is displayed, and a plurality of How stickers 31d registered to the app 9 are displayed (see FIG. 5D).

Those stickers 31 are pasted to the tile screen 23 by touching or tapping the stickers 31 desired to be pasted to the tile screen 23 while displaying each of the sticker windows 37a to 37d or by dragging the stickers 31 from each of the sticker windows to the tile screen 23.

While a case of pasting each of the stickers 31 for each purpose individually for the individual schedule data 30a has been described, a plurality of stickers 31 for the same purpose may be pasted as well. For example, the start time and the end time can be expressed by pasting a plurality of the Who stickers 31c and a plurality of the When stickers 31b. Further, as shown in the individual schedule data 30a2 of FIG. 4C, the stickers 31 of four pieces less for each purpose may be used.

The pasting positions of the stickers 31 may be anywhere within the tile screen 23 as long as the stickers configuring a single piece of the individual schedule data 30a are arranged in line laterally (see FIG. 4A and the like). After pasting, the user can drag the stickers and move them to arbitrary positions. The user can improve a sense of use and visibility, and enjoy the arrangement of the sticker layout of one's originality and ingenuity by changing the layout of the stickers 31 freely within a single tile screen 23.

Further, the stickers 31 pasted to the individual schedule data 30a can be cancelled as long as the sticker window 37 is being displayed. Thus, the user can easily change the stickers 31 of the individual schedule data 30a as many times as the user desires.

### Sticker Pasting Processing

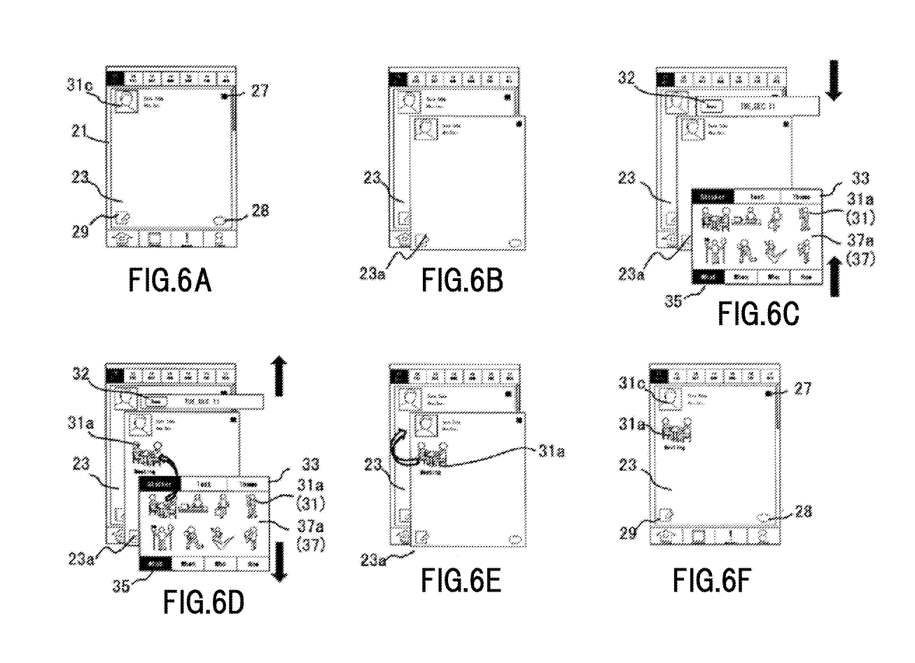

Pasting processing of the stickers 31a to 31d will be described by referring to FIG. 6.

First, when the input button 29 is pressed down (FIG. 6A), a pasting work tile screen 23a that is a copy of the tile screen 23 is generated, and it is displayed by being superimposed on the tile screen 23 so as to be viewed by the user (FIG. 6B).

Then, an execution button (Done) 32 appears by being superimposed on the pasting work tile screen 23a while moving sequentially from the upper end of the display screen 21 toward the center direction of the display screen. Further, the input selection menu 33, the sticker menu 35, and the sticker window 37 appear by sequentially moving from the bottom end of the display screen 21 toward the center of the display screen (FIG. 6C). When the move of each displayed items stops, the user hallucinates that the user oneself is looking at the tile screen 23 shown in FIG. 5A to FIG. 5d. Actually, however, the user is looking at the superimposed pasting work tile screen 23a, the execution button 32, the input selection menu 33, the sticker menu 35, and the sticker window 37.

Then, when the user selects the sticker 31 from the sticker window 37, the selected sticker 31 is pasted to the pasting work tile screen 23a (FIG. 6D).

When the execution button 32 is pressed down, the execution button 32 moves sequentially from the display screen center direction toward the upper end of the display screen 21 and disappears, and the execution button 32, the input selection menu 33, the sticker menu 35, and the sticker window 37 move sequentially from the display screen center direction toward the bottom end of the display screen 21 and disappear (FIG. 6E).

At last, the stickers 31 pasted to the pasting work tile screen 23a are copied and pasted to the tile screen 23, and the pasting work tile screen 23a is discarded (FIG. 6F). The user at last comes to see the tile screen 23 to which the sticker 31 is pasted.

As described, through pasting the sticker 31 to the tile screen 23 from the sticker window 37 via the pasting work tile screen 23a, the user can acquire a visual effect as if the sticker 31 is pasted directly to the tile screen from the sticker window 37. By executing this processing, the user can overcome visual stresses caused from the display processing such as executing a work by shifting to another work screen from the currently viewing screen as in the case of the conventional processing.

### Update of Schedule Data

Regarding the updated individual schedule data 30a on the inputted tile screen 23, when the execution button 32 is pressed down, the mobile terminal device 10 updates the individual schedule data 30a saved in the storage device 18 and transmits the updated individual schedule data 30a to the information sharing server 7 from the communication device 19 via the communication network 3.

As described, through instantly updating and keeping the individual schedule data 30a (schedule data 30) updated by the mobile terminal device 10 to the schedule data 30 saved in the information sharing server database 8, the storage device 18 of the mobile terminal device 10 can be synchronized with the information sharing server database 8. Further, when the mobile terminal device 10 of a friend makes an access to the information sharing server database 8, the user and the friend can view the latest updated individual schedule data 30a with a short time lag.

### Second Viewing Mode

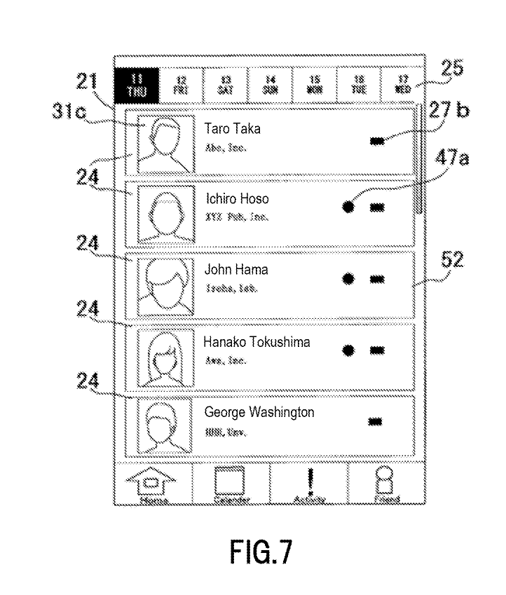

The embodiment includes a function of switching a first viewing mode 51 which displays the tile screen 23 shown in FIG. 4A and a second viewing mode 52 which displays a brick screen 24 shown in FIG. 7 by pressing down a viewing mode switching button 27.

As shown in FIG. 7, the brick screen 24 displays only a plurality of names of friends and the Who stickers 31c arranged in line vertically on one screen. The brick screen 24 is suited for searching the target friend from a plurality of friends since it displays only a plurality of names of friends and the Who stickers 31c arranged in line vertically on one screen.

For the friends displayed on the brick screen 24, the information of the friends registered as the friends of the user in the SNS server database 6 is used by being copied to the information sharing server database 8 as the information of a specified number of people at the first startup of the app 9 after installation. Thereafter, the user increases the number of registered friends while using the app 9. In the embodiment, there is no limit set in the largest registered number of people in the initial setting. However, the user may change the initial setting to be able to set and change the largest registered number as appropriate.

The brick screen 24 of the second viewing mode is displayed in a shape with the lateral length from one end to the other end of the display screen 21 and the vertical length is acquired by dividing the vertical length of the display screen 21 into a plurality of sections. While FIG. 7 shows a case of displaying five items from T1 to T5, the number of displayed items may be changed as appropriate within the range of the display screen 21. When the schedule data 30 after T5 is added, the added data 30 can be displayed by using the scroll bar 26 or by executing a scrolling action vertically with a swiping action.

Further, as the display order of the brick screens 24, T1 that is the schedule data 30 of the user is displayed at the position of the highest rank T1, and T2 to Tn of the schedule data 30 of the friends are displayed thereafter. The order of the brick screens 24 of the friends can be switched through operating the touch panel 15a of the input device 15 by dragging or the like. For example, it is possible to change the display order as “T1, T3, T1, T2, T5” and display by shifting T3 to the next rank of the user T1. When the display order of the brick screens 24 is changed, the display order of the tile screen 23 shown in FIG. 3 is also changed in an associated manner. Further, the display order information may be saved in the information sharing server database 8 so as to display in the changed order at the time of next startup.

In a case where the schedule data 30 (individual schedule data 30a) is registered, a mark 47a indicating that there is the individual schedule data 30a displayed on the brick screen 24 in the second viewing mode 52. The individual schedule data 30a may be registered to the date selected in the date display section 25 or one of the seven days shown in the date display section 25. Further, in a case where the user or the friend writes a comment, the mark 47a indicating that there is a comment is displayed. It is also possible to add a function of displaying the mark 47a by changing its shape for the case of the schedule data 30 and the comment, so that the user can distinguish which of the data exists at a glance. Moreover, the display method may be changed as appropriate.

Further, when a friend viewing mode switching button 27b is pressed down on the brick screen 24, the brick screen 24 (second viewing mode 52) is switched to display the tile screen 23 (first viewing mode 51) of the selected friend.

### Other Operations

The scroll bar 26 shown in FIG. 4A and the like has a function of scrolling the display screen 21 vertically by a dragging operation or by touching. In a case where the display content of the display screen 21 contains display information over a plurality of screens, the display information cannot be viewed by being hidden in the bottom direction of the display screen 21. Thus, the tile screen is scrolled vertically by operating the scroll bar 26 to view the hidden information.

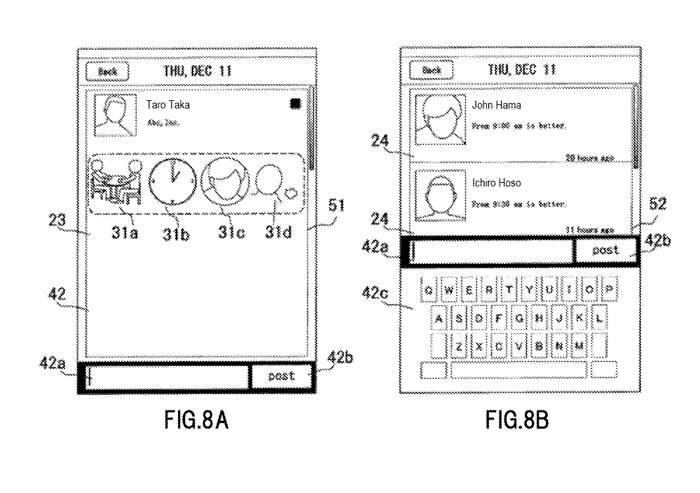

A comment button 28 shown in FIG. 4A and the like is pressed down to shift to a comment input screen 42 as shown in FIG. 8A and display a comment input section 42a and post button (Post) 42b to shift to a state where comments can be inputted to the tile screen 23 that is being displayed. Comments can be inputted for the user and the friends as well. Also, when the comment input section 42a is selected, a software keyboard 42c is displayed further as shown in FIG. 8B so that character input can be done easily. The inputted comment can be finalized and saved by pressing down the post button 42b in both of the screens shown in FIG. 8A and FIG. 8B.

With this function, the user can find out which of the individual schedule data 30a of the user the friend is interested in through checking the comment inputted by the friend. For example, the total number (the total of each schedule data 30, the total of each individual schedule data, the total of entire data, etc.) of the comments inputted by the friends may be displayed near the comment button 28. Further, based on the comments inputted from the friends, the user can change the individual schedule data 30a (time, place, and the like) flexibly and finalize the individual schedule data 30a at last.

As described above, the information is shared through disclosing the near-future (seven days) schedule to a specified number of people (friends) that are permitted to access, and the schedule can be changed and finalized flexibly according to the reactions by the comments made from the friends for that schedule.

Further, as described above, the user and the friends can make a comment on the concerned individual schedule data 30a, and it is also possible to provide a function of informing the friends that it is the execution date of the individual schedule data 30a by sending a message or an e-mail (recommend) or a function of sending a message or an e-mail to encourage the friends to view (remind).

### Main Menu

The main menu 40 displays buttons for selecting various kinds of functions of the present invention as shown in FIGS. 4A, 4B, and the like. Through pressing buttons, the display is shifted to screens for executing the capabilities of the functions. The buttons registered to the main menu 40 in the present invention area home button (Home) 40a, a calendar button (Calendar) 40b, an activity button (Activity) 40c, and a follow button (Friend) 40d. However, other function buttons may be added or currently registered buttons may be cancelled as well.

When the home button 40a is pressed down, the screen is discarded and shifted to the basic-state screen (home screen) shown in FIG. 4A even when one of the screens of the app 9 is being operated and viewed.

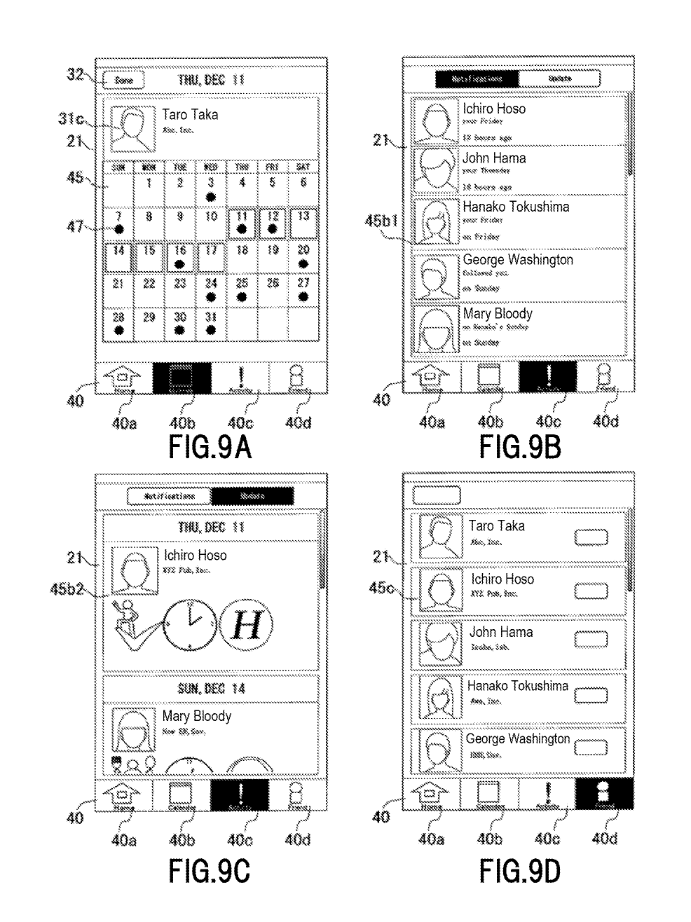

When the calendar button 40b is pressed down, the calendar screen 45a of one month unit is displayed as shown in FIG. 9A. By flicking the touch panel 15a (see FIG. 4A) of the display screen 21 to the left or right direction, the calendar screen 45a displays the past or future calendar of one month unit (not shown). Further, the seven days (seven days from the day of the use) displayed in the date display section 25 may be displayed in a conspicuous display form by changing the coloring, etc. For example, the dates displayed in the date display section 25 in FIG. 9A are shown with double frames. Further, in a case where there is the individual schedule data 30a or there is a comment from a friend, a calendar mark 47 is displayed at the corresponding date.

While the user can view the calendar display on the calendar screen 45a of the user oneself, the user cannot view the calendar screens 45a of the friends. The present invention discloses the near-future schedules, so that the period where the user can view the schedule data of the other people than the user is limited to be within the range of D1 to D7 shown in FIG. 3.

As shown in FIG. 4A, there is no tile screen 23 of the schedule data 30 out of the period other than the seven days displayed on the date display section 25, so that such screen is not displayed. However, the user oneself can view the individual schedule data 30a of the period other than the seven days by designating the date from the calendar display screen.

As shown in FIG. 9A, when the activity button 40c is pressed down, the screen is shifted to a first activity screen 45b1. The first activity screen 45b1 displays the Who sticker 31c and the information of the name and the like of the friend that has taken some kind of action to the individual schedule data 30a of the user in a tile form. For example, displayed are: who has viewed the individual schedule data 30a of the user of what date; the viewed time; the date and time of a comment made by the friend to the user if there is any; request for informing to the friend; and the like.

Thereby, the user can find out there are comments and communication notes from the friend and to find out which of the own individual schedule 30a the friend is interested through viewing the first activity screen 45b1. The user can use such comments and interests as the judgment materials for revising the individual schedule data 30a.

Further, by pressing down the “Update” button on the first activity screen 45b1, the screen is shifted to a second activity screen 45b2 as shown in FIG. 9C. The second activity screen displays information of the updated individual schedule data 30a when the friend updates the own individual schedule data 30a. The user can find out that the individual schedule data 30a of the friend the user is interested in is updated by viewing the second activity screen.

When the follow button 40d is pressed down as shown in FIG. 9D, the screen is shifted to the follow screen 45c. The follow screen 45c displays the friend and a list of the users other than the friend with the brick screens 24, and adding and canceling actions and the like of the friends are executed therethrough. The follow screen 45c includes buttons (not shown) for adding and canceling the friends and a button (not shown) for making an inquiry to the friends whether or not to register. When the friend is added or cancelled, for example, the number of friends displayed on the brick screens 24 shown in FIG. 7 increases or decreases.

### Input Selection Menu

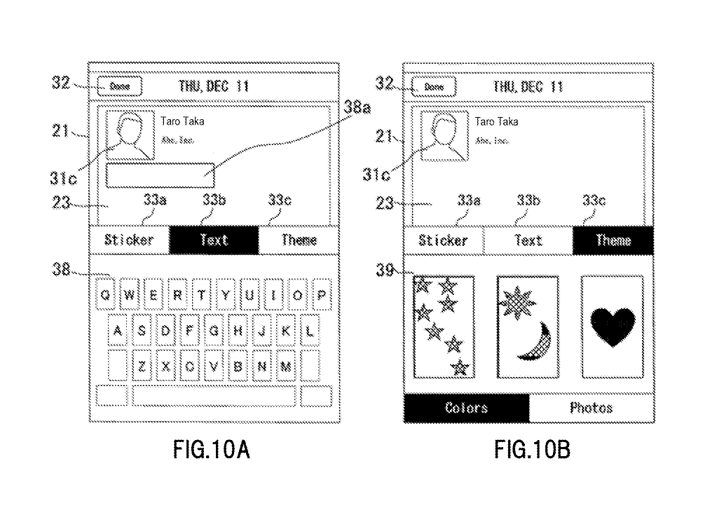

As shown in FIG. 10A, when a text input button (Text) 33b in the input selection menu 33 is pressed down, the screen is shifted to a text input screen 38. The user can input characters to a text input section 38a of the tile screen 23 by using the software keyboard displayed on the text input screen 38. Further, the user can input not only to the tile screen 23 of the user oneself but also to the screens of the friends. In that case, the mark 47a (see FIG. 7) indicating that there is a comment being inputted is informed to the friend for whom the comment is inputted.

Regarding the update of the inputted text on the tile screen 23, the mobile terminal device 10 transmits the updated individual schedule data 30a to the information sharing server 7 from the communication device 19 via the communication network 3 when the execution button (Done) 32 is pressed down.

As shown in FIG. 10C, when a wallpaper input button (Theme) 33c in the input selection menu 33 is pressed down, the screen is shifted to a wallpaper changing screen 39. The user can select an image displayed on the wallpaper changing screen 39 and use it as a pattern displayed on the background of the tile screen 23. For the wallpaper, not only those registered to the app 9 in advance but also photographs captured by the user into the mobile terminal device 10 can be used. For updating the inputted wallpaper on the tile screen 23, the execution button 32 is pressed down. As described above, when the execution button 32 is pressed down, the mobile terminal device 10 transmits the updated individual schedule data 30a (see FIGS. 4A, 4C, and the like) to the information sharing server 7 from the communication device 19 via the communication network 3.

### Explanations of Measures

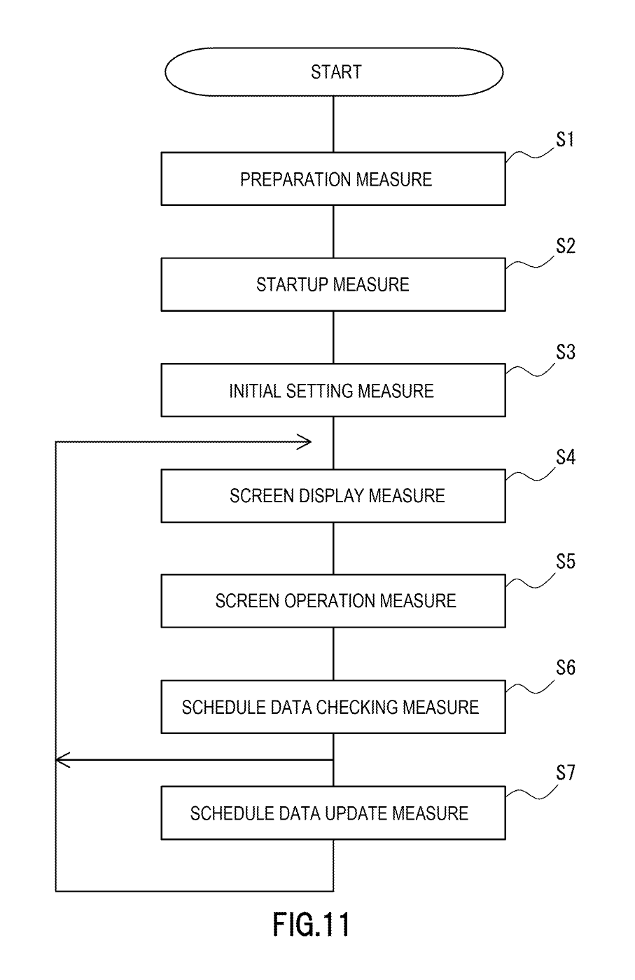

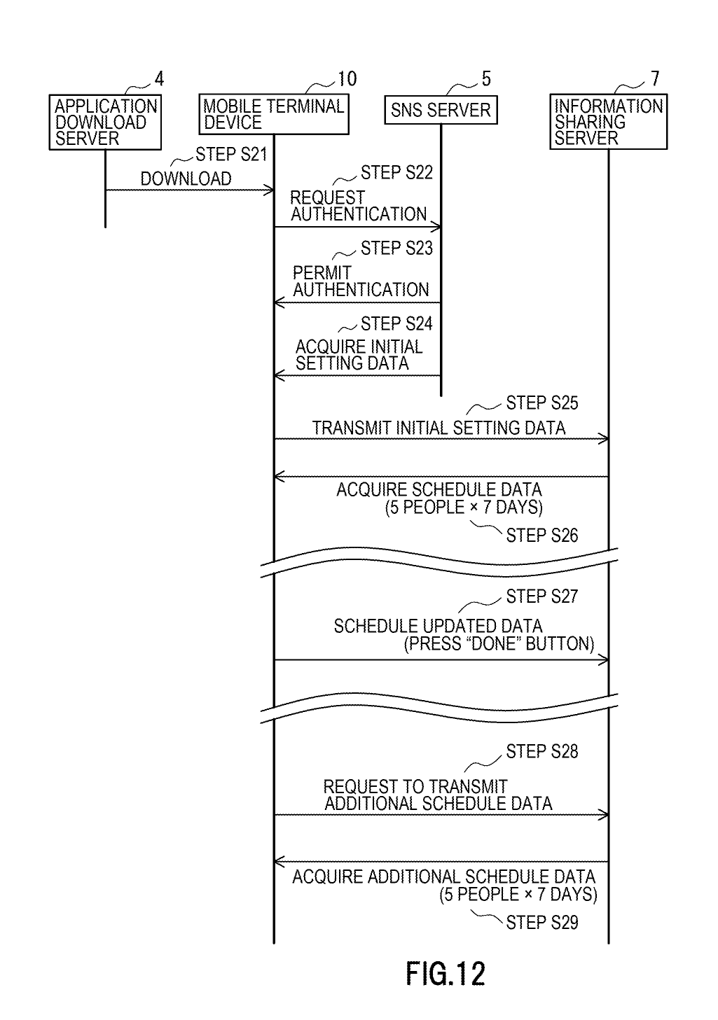

Next, the flow of the processing of the present invention will be described by referring to FIG. 11 and FIG. 12. FIG. 11 shows the flow of the basic processing of the information sharing system according to the present invention, and FIG. 11 is a sequence chart of the processing of the information sharing system according to the present invention.

As shown in FIG. 11 and FIG. 12, a preparation measure (step S1) is a means for downloading and installing the app 9 when the app 9 is used in the mobile terminal device 10 for the first time.

In a case where the app 9 is not installed in the mobile terminal device 10, the user operates the input device 15 of the mobile terminal device 10, dispatches a command from the control unit 13, and makes an access to the application software download server 4 from the communication device 19 via the communication network 3. Then, the user executes a prescribed operation to download the app 9 from the application software download server 4 via the communication network 3 and save it inside the storage device 18 of the mobile terminal device 10 via the communication device 19 (step S21). Then, the downloaded app 9 is installed inside the storage device 18 and set to be in an executable state. When the app 9 is already installed inside the storage device 18, execution of the preparation measure is omitted.

Then, in a startup measure (step S2), when the app 9 is started up in the mobile terminal device 10, the app 9 dispatches a command from the control unit 13 to request authentication indicating that the procedure has been completed and transmits it to the SNS server 5 from the communication device 19 via the communication network 3 for connecting to the SNS server 5 (step S22). The SNS server 5 responds to the mobile terminal device 10 to permit authentication when the authentication request is proper (step S23). Then, the SNS server 5 transmits initial setting data regarding the user accumulated in the SNS server database 6 to the mobile terminal device 10 (step S24). The app 9 saves the initial setting data in the storage device 18 of the mobile terminal device 10 via the communication device 19 from the application software download server 4 via the communication network 3. The initial setting data is the personal information of the user, and contains the basic information (name, age), a picture of the face, the friend information, and the like.

Then, the procedure is shifted to an initial setting measure (step S3). In the initial setting measure, the app 9 of the mobile terminal device 10 reads out the initial setting data acquired in step S24 and transmits it to the information sharing server 7 from the communication device via the communication network 3 (step S25). The information sharing server 7 registers the received initial setting data to the information sharing server database 8 and, thereafter, uses it as the basic information for building the schedule data 30 of the user.

In a case where startup is the first time and there is no setting data of the mobile terminal device 10 in the information sharing server database 8, the basic information (name, age), a picture of the face, the friend information and the like is transmitted for the initial setting data to be transmitted assuming that there is no basic information of the user in the information sharing server 7. Further, when making an access to the information sharing server 7 for the second time and thereafter, the picture of the face, the friend information, and the like are transmitted without transmitting the basic information assuming that the basic information has already been registered to the information sharing server database 8.

Then, the information sharing server 7 acquires the schedule data 30 (illustrated in FIGS. 4A, 4C, and the like) of the user from the information sharing server database 8, and sends the acquired schedule data 30 to the mobile terminal device 10 (step S26). The mobile terminal device 10 saves the received schedule data 30 in the storage device 18.

Then, as a screen display measure (step S4), the control unit 13 gets the schedule data 30 saved in the storage device 18 from the storage device 18 and displays it on the display screen 21 (illustrated in FIG. 4A and the like) of the display device 14. As shown in FIG. 3, the schedule data 30 acquired at first after the startup is for 35 pieces of the tile screens 23, i.e., 5 people (T1 to T5)×7 days (D1 to D7). As described, through displaying it on the display device 14, the user can view the schedule data 30. Further, as shown in FIG. 4, the screen immediately after the startup displays the tile screen 23 (T1D1 (home screen) shown in FIG. 3) of the user on the use date.

Furthermore, in the screen display measure, display on the tile screen 23 can be switched mutually between the first viewing mode 51 and the second viewing mode 52 where a plurality of brick screens 24 are displayed in the vertical direction by pressing down the viewing mode switching button 27.

Next, as a screen operation measure (step S5), the control unit 13 detects the layout of the tile screen 23 regarding the schedule data 30 displayed on the display screen 21 and detects that the user has operated the touch panel 15a of the input device 15, and executes the display control of the screen scrolling.

FIG. 3 is an illustration schematically showing the layout of the tile screen 23. T1, T2, - - - , and Tn are applied on the vertical axis for each person, and D1, D2, - - - , and D7 are applied on the lateral axis for each date for seven days. As described above in the screen scrolling method, when viewing the schedule of the user of the next day from the home screen (T1D1) shown in FIG. 4, the data displayed on the display screen is shifted to the tile screen 23 (T1D2) located in conceptually the upper right direction that is opposite from the swiping direction when the screen is scrolled (swiped) in the left direction with the touch panel 15a. Further, scrolling in the oblique directions is restricted.

In a schedule data checking measure (step S6), executed are processing for checking the schedule data 30 (individual schedule data 30a) displayed on the display screen 21 done by the user and the friends, and processing of data for updating the schedule data 30 (individual schedule data 30a) done by the user, checking the comments from the friends, and writing comments to the friends.

First, the user and the friends check the individual schedule data 30a of oneself and the others, and check the comments from the friends on the first activity screen 45b1. Also, only the user can check the own past and future schedules on the calendar screen 45a. Further, the user can read the comments made on the individual schedule data 30a, and use those as the reference for changing and checking the individual schedule data 30a.

As shown in FIGS. 5A to 5D, FIG. 10A and FIG. 10B, input and change of the individual schedule data 30a are finalized by pressing down the execution button 32. Further, writing of a comment is finalized by pressing down the “Post” button (step S27).

A schedule updating measure (step S7) is the processing where the user registers the individual schedule data 30a or the content of the comment finalized by the schedule data checking measure (step S6) is registered to the storage device 18 and the information sharing server database 8 of the information sharing server 7.

First, the control unit 13 updates the content stored in the storage device 18 with the individual schedule data 30a or the content of the comment finalized by the user in the individual schedule data checking measure (step S6). Then, the control unit 13 transmits the updated individual schedule data 30a (schedule data 30) and comment to the information sharing server 7 from the communication device via the communication network 3. The information sharing server 7 registers the received updated individual schedule data 30a and comment to the information sharing server database 8.

In this manner, through instantly transmitting the individual schedule data 30a (schedule data 30) and the comment updated in the mobile terminal device 10 to the information sharing server and updating and saving the comment of the schedule data 30 saved in the information sharing server database 8, the content within the storage device 18 of the own mobile terminal device 10 can be updated and the new information can be disclosed to the friends at the same time.

In the screen display measure (step S4), in a case where there is a command for scrolling in the lower direction next while the user is scrolling the tile screen with a finger in the vertical direction, e.g., while the screen T5D1 is being displayed, there is no new tile screen to be displayed saved in the storage device 18. Thus, the central processing device of the terminal device 1 sends a request to the information sharing server 7 to transmit the schedule data 30 of the 35 pieces (step S28), i.e., next 5 people (T6 to T10)×7 days (D1 to D7) when one of the screens of T5D1 to T5D7 as the last row of the schedule data 30 is displayed.

In response to the transmission request, the information sharing server 7 acquires the schedule data 30 of the next 5 people (T6 to T10)×7 days (D1 to D7) from the information sharing server database 8 as shown in FIG. 3 and transmits the acquired schedule data 30 to the mobile terminal device 10 (step S29). The mobile terminal device 10 saves the transmitted schedule data 30 in the storage device 18.

Thereafter, when one of the schedule data 30 of the last row of TmD1 to TmD7 is displayed, the schedule data 30 of 35 tile screens of the next 5 people (Tm+1 to Tm+5)×7 days (D1 to D7) are acquired from the information sharing server 7 in the same manner.

While a case of acquiring the schedule data of 35 pieces of the next 5 people (Tm+1 to Tm+5)×7 days (D1 to D7) as the additional screens has been described, the number of the schedule data to be acquired is not limited to be 5 people. It is also possible to acquire the schedule data 30 for proper number of people as necessary (e.g., for 10 people, for 20 people, and the like) by considering the transmission/reception condition of the storage device 18, the communication device 19, and the communication network.

### Second Embodiment

Note that the above-described information sharing system 1 can also be achieved by hardware, software, and a combination of those. Further, the information sharing method employed in the above-described information sharing system 1 can also be achieved by hardware, software, and a combination of those. To achieve them by software means that a program is loaded from a recording medium or the like and executed by a computer.

The program can be stored in a recording medium and supplied to the computer. The recording media include magnetic recording media (floppy (registered trademark) disk, a magnetic tape, a hard disk drive, and the like), magneto-optical recording media (CD-ROM, DVD-ROM, BL-ROM, and the like), and semiconductor memories (mask ROM, PROM, EPROM, flash ROM, RAM (random access memory), and the like). Further, the program can also be supplied to the computer via an electric communication line.

### Additional Function

In the first embodiment described above, the friends are defined as the continuous schedule data (T1, T2, - - - , Tn) as shown in FIG. 3. However, it is also possible to build the schedule data in a group unit. For example, a tab may be applied to each family, each work place, and each circle and displayed.

Further, as a measure for finding the registered information of the friends, a profile screen (Profile) 60 may be provided and a function of displaying the name of the owner of the Who sticker 31c, self-introduction, the individual schedule data 30a, and the like may be provided. For shifting to the profile screen 60, it is easy and preferable for the user to tap the Who sticker 31c as the picture of the face pasted on the tile screen 23 and the brick screen 24 as shown in FIG. 4A, FIG. 7, and the like.

The present invention can be embodied as a great number of forms without departing from the essential characteristics and the technical spirit thereof. It is therefore to be understood that the embodiments described above are solely provided for the explanations and that the present invention is not limited thereto.

1. An information sharing system, comprising at least an information sharing server, an information sharing server database that is connected to the information sharing server and saves schedule data, and a mobile terminal device,
the mobile terminal device comprising a control unit, a display device, an input device, a storage device, and a communication device, wherein:
the control unit acquires into the storage device the schedule data for a plurality of days and a plurality of people from the information sharing server database connected to the information sharing server via the communication device and the communication network, and displays the acquired schedule data on a display screen of the display device with a tile screen; and
the tile screen displayed on the display screen is scrolled in lateral directions and vertical directions by operating the input device for display.

2. The information sharing system according to claim 1, wherein the tile screen displays the schedule data of one person for one day on an entire region of the display screen.

3. The information sharing system according to claim 1, wherein:
the schedule data contains a single or a plurality of individual schedule data that can be displayed on a single tile screen; and
the individual schedule data is configured with a single sticker or a plurality of stickers.

4. The information sharing system according to claim 3, wherein the plurality of stickers are stored by being classified according to each purpose.

5. The information sharing system according to claim 1, wherein a first viewing mode for displaying the tile screen on the display screen of the display device and a second viewing mode for displaying a plurality of brick screens can be switched mutually.

6. The information sharing system according to claim 1, wherein scrolling of the tile screen displayed on the display screen stops and displays each of the tile screens.

7. The information sharing system according to claim 1, wherein the schedule data for the plurality of days acquired from the information sharing server database are the schedule data for seven days.

8. The information sharing system according to claim 3, comprising a display measure which indicates that a comment to be inputted to the schedule data is already being inputted to the individual schedule data of another user on the brick screen.

9. An information sharing method used with an information sharing system which comprises at least an information sharing server, an information sharing server database that is connected to the information sharing server and saves schedule data, and a mobile terminal device,
the mobile terminal device comprising a control unit, a display device, an input device, a storage device, and a communication device, wherein:
the control unit acquires into the storage device the schedule data for a plurality of days and a plurality of people from the information sharing server database connected to the information sharing server via the communication device and the communication network, and displays the acquired schedule data on a display screen of the display device with a tile screen; and
the tile screen displayed on the display screen is scrolled in lateral directions and vertical directions by operating the input device for display.

10. An information sharing program used with an information sharing system which comprises at least an information sharing server, an information sharing server database that is connected to the information sharing server and saves schedule data, and a mobile terminal device,
the mobile terminal device comprising a control unit, a display device, an input device, a storage device, and a communication device, wherein:
the control unit acquires into the storage device the schedule data for a plurality of days and a plurality of people from the information sharing server database connected to the information sharing server via the communication device and the communication network, and displays the acquired schedule data on a display screen of the display device with a tile screen; and
the tile screen displayed on the display screen is scrolled in lateral directions and vertical directions by operating the input device for display.

11. The information sharing system according to claim 2, wherein a first viewing mode for displaying the tile screen on the display screen of the display device and a second viewing mode for displaying a plurality of brick screens can be switched mutually.

12. The information sharing system according to claim 2, wherein scrolling of the tile screen displayed on the display screen stops and displays each of the tile screens.
